(19) United States
(12) Patent Application Publication
(10) Pub. No.: US 2026/0258206 A1
(43) Pub. Date: Sep. 3, 2026

(54) Hydrogel and Method of Preparing the Same

(71) Applicant: Nanyang Technological University, Singapore (SG)

(72) Inventors: Qingyu YAN, Singapore (SG); Ziyue WEN, Singapore (SG)

(21) Appl. No.: 19/553,832

(22) Filed: Mar. 2, 2026

(30) Foreign Application Priority Data
Mar. 3, 2025 (SG) 10202500541S

(51) Int. Cl. C08J 3/075; C08J 3/24; C08K 3/30; H01M 10/36

(52) U.S. Cl. CPC C08J 3/075; C08J 3/24; C08K 3/30; H01M 10/36; C08J 2383/06; C08J 2383/08; C08K 2003/3081; H01M 2300/0011

(57) ABSTRACT

The present disclosure relates to a hydrogel comprising: a charge carrier; and a polymer matrix comprising a network of crosslinked poly(A)-co-poly(B), wherein A is an organosilane and B is a tetraalkoxysilane. The present disclosure also relates to a method of preparing a hydrogel, comprising the steps of: a. adding an organosilane and a tetraalkoxysilane to an aqueous solution of a metal salt; and b. resting the solution to form the hydrogel. The present disclosure further relates to a hydrogel obtained by the method as disclosed herein. The present disclosure also an electrochemical cell comprising the hydrogel as disclosed herein as an electrolyte.

### CROSS-REFERENCE TO RELATED APPLICATIONS

This application claims priority to Singapore application no. 10202500541S filed with the Intellectual Property Office of Singapore on 3 Mar. 2025, the contents of which is hereby incorporated by reference in its entirety for all purposes.

### TECHNICAL FIELD

The present disclosure generally relates to hydrogels, and more particularly relates to hydrogel electrolytes. The present disclosure also relates to methods of producing said hydrogels and their uses.

### BACKGROUND ART

With the growing demand for sustainable energy, lithium-ion batteries have emerged as the predominant power supplies for electric vehicles and portable electronic devices. However, due to limited lithium resources and safety issues, it is imperative to explore next-generation electrochemical storage systems. Aqueous aluminum ion batteries (AAIBs) exhibit promising prospects for large-scale energy storage due to high specific capacity (8035 mAh cm⁻³, 2976 mAh g⁻¹), high abundance, and inherent safety characteristics of aluminum (Al) metal anodes. Currently in the early stages of development, AAIBs confront several challenges that require attention, particularly regarding the electrolyte/Al anode interface. Specifically, the reversible electrochemical deposition of Al is hindered in traditional aqueous electrolytes due to the competitive reduction between Al³⁺/Al (−1.66 V vs standard hydrogen electrode) and H⁺/H₂, leading to a parasitic hydrogen evolution rection (HER). Thus, there is an urgent need to design electrolytes with a wide electrochemical stability window (ESW) in order to suppress water decomposition and Al anode corrosion.

To date, various strategies have been employed to inhibit HER in aqueous electrolytes, such as “water-in-salt” concept and incorporation of functional additives or organic solvents. These approaches aim to reduce water reactivity by modulating the solvation structure, thereby alleviating interfacial side reactions. Despite advancements in regulating aqueous electrolytes, several challenges remain for further development of rechargeable AAIBs: 1) suppression of side reactions at the anode surface; 2) inherent evaporation and leakage of liquid electrolytes; and 3) compromised mechanical stability of electrode/electrolyte interface under external force strain. In contrast, gel polymer electrolytes are widely recognized for their superior leak resistance and enhanced flexibility. However, their complex preparation processes and associated environmental concerns pose limitations on their large-scale development and commercialization.

Thus, there is a need to provide an electrolyte that overcomes, or at least ameliorates one or more of the disadvantages described above.

### SUMMARY

In an aspect of the present disclosure, there is provided a hydrogel comprising:
a charge carrier; and
a polymer matrix comprising a network of crosslinked poly(A)-co-poly(B),
   wherein A is an organosilane and B is a tetraalkoxysilane.

Advantageously, when the hydrogel is used as an electrolyte in an electrochemical cell, the hydrogel as disclosed may exhibit a broadened electrochemical stability window (ESW) of about 2.50 to about 2.80 V, suppress the hydrogen evolution reaction (HER) in an aqueous electrochemical cell, maintain a hydrogen evolution potential of about −0.60 V to about −0.70 V, achieve an ionic conductivity of about 2×10⁻³ S cm⁻¹ to about 4×10⁻³ S cm⁻¹ at 25° C. with a water content between 20 to 40 wt %. The hydrogel electrolyte may also not be ignited by an exposure to an ignition source of up to 8 seconds, exhibit high mechanical flexibility under various mechanical stresses. The hydrogel electrolyte may also advantageously be stable when exposed to air during operation of the electrochemical cell. The hydrogel electrolyte may advantageously demonstrate reversible and uniform deposition and stripping of Al with reduced side reactions without dendrite formation when used in an Al electrochemical cell.

In another aspect of the present disclosure, there is provided a method of preparing a hydrogel, comprising:
a. adding an organosilane and a tetraalkoxysilane to an aqueous solution of a metal salt; and
b. resting the solution to form the hydrogel.

Advantageously, production of such hydrogels may be easily scaled up when using the above method.

In a further aspect of the present disclosure, there is provided a hydrogel obtained by the method as disclosed herein.

In another aspect of the present disclosure, there is provided an electrochemical cell comprising the hydrogel as disclosed herein as an electrolyte.

Advantageously, the electrochemical cell comprising the hydrogel as an electrolyte may exhibit a stable cycling performance of about 0.15 V over 300 hours, and a cycling stability with an initial discharge capacity of about 70 mAh g⁻¹ to 80 mAh g⁻¹ with a high average Coulombic efficiency of >about 99.0%, while maintaining a capacity retention of >90% after about 100 to about 500 cycles. The electrochemical cell may further exhibit a constant open circuit voltage (OCV) during a self-discharge process through a resting period of 20 hours, and also exhibit average discharge capacities of about 90 to about 95, about 65 to about 70, about 60 to about 65 and about 55 to about 60 mAh g⁻¹ at current densities of 50, 80, 100 and 150 mA g⁻¹ respectively.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

As used herein, the term “charge carrier” refers to ions that migrate through an electrolyte between an anode and a cathode in an electrochemical cell.

As used herein, the term “polar functional group” refers to a substituent or moiety that confers a polarity to the molecule and determine the molecule's characteristic chemical reactions and compatibility towards other chemicals. Functional groups are classified as having polar or nonpolar properties depending on their atomic composition and organization. The term “polar” describes a group which has a specific orientation on the molecule and an electronegativity high enough to determine an unbalanced distribution of electrons and therefore electric charge across the whole molecule.

Examples of polar functional groups are oxygen based polar functional groups, such as hydroxyl group, carbonyl group, carboxyl group, ester group, or nitrogen based polar functional groups such as amide group or amino group, or combinations thereof.

As used herein, the term “alkyl” refers to C₁₋₆ inclusive, e.g., an alkyl group of 1, 2, 3, 4, 5, or 6 carbons, linear (i.e., “straight-chain”), branched, or cyclic, saturated or unsaturated (i.e., alkenyl and alkynyl) hydrocarbon chains, including for example, methyl, ethyl, propyl, isopropyl, butyl, isobutyl, tert-butyl, pentyl, hexyl, ethenyl, propenyl, butenyl, pentenyl, hexenyl, butadienyl, propynyl, butynyl, pentynyl, hexynyl, and allenyl groups. “Branched” refers to an alkyl group, such as methyl, ethyl or propyl, is attached to a linear alkyl chain. As used herein, the term “linear” refers to hydrocarbons containing at least 2 carbon atoms, and/or other heteroatoms (e.g., O, N, S, Se, P) that may be saturated or unsaturated, but does not contain any cyclic functional groups.

As used herein, “amorphous” refers to a solid form of a molecule, atom, and/or ions that is not crystalline.

Unless the context requires otherwise or specifically stated to the contrary, integers, steps, or elements of the invention recited herein as singular integers, steps or elements clearly encompass both singular and plural forms of the recited integers, steps or elements.

The word “substantially” does not exclude “completely” e.g. a composition which is “substantially free” from Y may be completely free from Y. Where necessary, the word “substantially” may be omitted from the definition of the invention.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1A is a diagram of a hydrogel electrolyte in accordance with an embodiment of the present invention and its molecular structure thereof.

FIG. 1B is a diagram showing the electrostatic potential of a precursor of the embodiment of FIG. 1A.

FIG. 1C is a graph depicting the binding energies of H₂O—H₂O, H₂O-TU(O) and H₂O-TU(NH).

FIG. 1D is a graph depicting the linear sweep voltammetry (LSV) profiles of the embodiment of FIG. 1A and a comparative embodiment. The inset depicts the magnification diagram of hydrogen evolution potential.

FIG. 2A is a pair of digital images depicting a hydrogel in accordance with an embodiment of the present invention (HE) and a comparative embodiment (LE).

FIG. 2B is a series of digital images depicting the self-healing properties and flexibility of the embodiment of FIG. 2A.

FIG. 2C is a scanning electron microscope (SEM) image with a scale bar of 2 μm of the Si—O—Si networks within the embodiment of FIG. 2A.

FIG. 2D is an X-ray diffraction (XRD) spectrum of the embodiment of FIG. 2A.

FIG. 2E is a series of Fourier Transform Infrared (FTIR) spectra of the embodiment of FIG. 2A (HE) and comparative embodiments (LE and TU).

FIG. 2F is a graph depicting the ionic conductivity of the embodiment of FIG. 2A from 25 to 80° C. obtained from electrochemical impedance spectroscopy.

FIG. 2G is a series of digital images of combustion tests for glass fibers saturated with the embodiment of FIG. 2A.

FIG. 2H is a series of digital images of combustion tests for glass fibers saturated with a comparative embodiment (LE).

FIG. 3 is a digital image showing the flexibility of a glass fiber immersed with a hydrogel in accordance with an embodiment of the present invention.

FIG. 4 is a series of FTIR spectra of a hydrogel in accordance with an embodiment of the present invention (HE) and comparative embodiments (LE and TU).

FIG. 5 is a graph depicting the temperature-ionic conductivity of a hydrogel in accordance with an embodiment of the present invention from 25° C. to 80° C.

FIG. 6A is a graph depicting the galvanostatic charge/discharge profiles of a comparative embodiment (symmetrical Al∥Al cells) at a current density of 0.05 mA cm⁻² and areal capacity of 0.05 mAh cm⁻². The inset depicts the magnification cycling performance of the comparative embodiment at 50-54 h, 150-154 h and 253-257 h.

FIG. 6B is a series of X-ray photoelectron spectroscopy (XPS) spectra of F Is, Al 2p and S 2p from cycled Al metal from the embodiment of FIG. 6A.

FIG. 6C is a series of Time-of-Flight Secondary Ion Mass Spectrometry (ToF-SIMS) analysis of the cycled Al metal of FIG. 6B.

FIG. 7 is a SEM image of an Al surface cycled from a Al|HE|Al electrochemical cell in accordance with an embodiment of the present invention.

FIG. 8 is a 2D mapping image of the cycled Al from the embodiment of FIG. 7.

FIG. 9 is a graph depicting the profiles of OTF⁻, AlF₄⁻, AlO₂⁻ and S⁻ secondary ions against the sputtering time.

FIG. 10A is a series of graphs depicting the in-situ Differential Electrochemical Mass Spectrometry (DEMS) testing for a comparative embodiment (Al|LE|KNHCF).

FIG. 10B is a series of graphs depicting the in-situ DEMS testing for an electrochemical cell (Al HE|KNHCF) in accordance with an embodiment of the present invention.

FIG. 10C is a series of optical images of gas evolution in the comparative embodiment of FIG. 10A at 0.3 mA cm⁻² by in-situ optical microscope.

FIG. 10D a series of optical images of gas evolution in the embodiment of FIG. 10B at 0.3 mA cm⁻² by in-situ optical microscope.

FIG. 10E is a schematic illustration of the Al interface in the comparative embodiment of FIG. 10A.

FIG. 10F is a schematic illustration of the Al interface in the embodiment of FIG. 10B.

FIG. 11 is a Nyquist plot of an electrochemical cell in accordance with an embodiment of the present invention.

FIG. 12A is a graph depicting the cycling performance of an electrochemical cell in accordance with an embodiment of the present invention (Al|HE|KNHCF) and a comparative embodiment (Al|LE|KNHCF) at a current density of 100 mA g⁻¹.

FIG. 12B is a series or digital photos of the embodiment of the present invention and comparative embodiment of FIG. 12A after cycling.

FIG. 12C is a graph depicting the charge/discharge capacity-voltage curves of the 40th cycle of the embodiment of the present invention of FIG. 12A.

FIG. 12D is a series of cyclic voltammetry curves of the embodiment of the present invention of FIG. 12A at a scan rate of 0.3 mV s⁻¹.

FIG. 12E is a graph showing the open circuit voltage (OCV) decay with time of the embodiment of the present invention and comparative embodiment of FIG. 12A.

FIG. 12F is a graph depicting the rate performance of the embodiment of the present invention and comparative embodiment of FIG. 12A at current densities of 50, 80, 100 and 150 mA g⁻¹.

FIG. 12G is a series of digital images depicting the OCV of the embodiment of FIG. 12D under bending, folding and cutting.

FIG. 13 is a graph showing the charge and discharge curves of an electrochemical cell in accordance with an embodiment of the present invention from 50 to 150 mA g⁻¹.

FIG. 14 is a series of digital images depicting the OCV of an electrochemical cell in accordance with an embodiment of the present invention under bending, folding and cutting.

### DETAILED DISCLOSURE OF EMBODIMENTS

Provided herein is a hydrogel comprising:
a charge carrier; and
a polymer matrix comprising a network of crosslinked poly(A)-co-poly(B),
   wherein A is an organosilane and B is a tetraalkoxysilane.

A may be a compound of Formula (I):

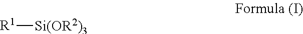

wherein R¹ is a C₁-C₆alkyl substituted with at least one R³;
each R² is independently a C₁-C₆alkyl; and
R³ is a polar functional group.

R¹ may be methylurea, ethylurea, propylurea, butylurea, pentylurea, or hexylurea. R¹ may be aminomethyl, aminoethyl, aminopropyl, aminobutyl, aminopentyl, or aminohexyl. R¹ may be methyl methacrylate, ethyl methacrylate, propyl methacrylate, butyl methacrylate, pentyl methacrylate, or hexyl methacrylate. R¹ may be hydroxymethyl, hydroxyethyl, hydroxypropyl, hydroxybutyl, hydroxypentyl, or hydroxyhexyl. R¹ may be carboxymethyl, carboxyethyl, carboxypropyl, carboxybutyl, carboxypentyl, or carboxyhexyl. R¹ may be carbamoylmethyl, carbamoylethyl, carbamoylpropyl, carbamoylbutyl, carbamoylpentyl, or carbamoylhexyl.

R³ may be a hydrophilic group. R³ may be capable of forming hydrogen bonds with water disposed within the hydrogel. R³ may be independently selected from the group consisting of —NH₂, —OH, —C(O)OH, —C(O)—NH₂, —O—C(O)—(CH₃)C═CH₂ and —N(H)—C(O)—NH₂. Advantageously, when R³ comprises an amino group, inert N₂ may be generated from thermal decomposition of the amino group, which may contribute to the hydrogel's resistance to ignition.

Advantageously, R³ being a polar functional group may advantageously promote the aggregation of H₂O molecules around the Si—O—Si chains while establishing ion transport channels, thus facilitating rapid ion migration under lean-water conditions. R³ may also form hydrogen bonds with H₂O molecules disposed within the hydrogel, which may disrupt the native hydrogen bond network of water, effectively reducing water activity and enhancing electrolyte stability, thereby mitigating HER. The constituents of R³ may exhibit a stronger electrostatic interaction with water as compared to water dimers.

A may be selected from the group consisting of 1-[3-(trimethoxysilyl)propyl]urea, (3-aminopropyl)triethoxysilane and 3-(trimethoxysilyl)propyl methacrylate.

B may be Si(OR⁴)₄, wherein each R⁴ is independently a C₁-C₆ alkyl. B may be tetramethyl orthosilicate, tetraethyl orthosilicate, tetrapropyl orthosilicate, tetrabutyl orthosilicate, tetrapentyl orthosilicate, or tetrahexyl orthosilicate.

The charge carrier may comprise Al³⁺, Zn²⁺, Li⁺, Na⁺, K⁺, Ca²⁺, or Mg²⁺. The charge carrier may be present in the hydrogel in the form of a salt. The salt may be an aqueous salt. The salt may further comprise counteranions selected from the group consisting of: [OTF]⁻, Cl⁻, SO₄²⁻, [OAc]⁻, or Tf₂N⁻. When the charge carrier is Al³⁺ and the counteranion is OTF, the OTF anion may be preferentially reductively decomposed in a solid electrolyte interface between an aluminium electrode and the hydrogel, which protects the electrode, promotes Al nucleation, and uniform deposition while avoiding direct contact between water and the aluminium electrode, thereby mitigating side reactions and facilitating long-term cycling performance.

The hydrogel may advantageously exhibit a low migration barrier for the charge carrier within the hydrogel, for example, about 12 kJ mol⁻¹ to about 16 kJ mol⁻¹ for an Al³⁺ charge carrier.

The polymer matrix may be a three-dimensional (3D) inorganic/organic hybrid structure. Advantageously, the 3D hybrid structure may allow the hydrogel to exhibit macroscopic morphological stability. Further advantageously, due to the structure of the polymer matrix, the hydrogel may exhibit self-healing properties and mechanical flexibility, which advantageously allows the hydrogel to exhibit enhanced safety when used in an electrochemical cell.

The hydrogel may further comprise water at a water content in a range of from about 20 wt % to about 60 wt %, from about 20 wt % to about 55 wt %, from about 20 wt % to about 50 wt %, from about 20 wt % to about 45 wt %, from about 20 wt % to about 40 wt %, from about 20 wt % to about 35 wt %, from about 20 wt % to about 30 wt %, from about 20 wt % to about 25 wt %, from about 20 wt % to about 23 wt %, or from about 23 wt % to about 60 wt %, from about 25 wt % to about 60 wt %, from about 30 wt % to about 60 wt %, from about 35 wt % to about 60 wt %, from about 40 wt % to about 60 wt %, from about 45 wt % to about 60 wt %, from about 50 wt % to about 60 wt %, from about 55 wt % to about 60 wt %, or about 20 wt %, about 23 wt %, about 25 wt %, about 30 wt %, about 35 wt %, about 40 wt %, about 45 wt %, about 50 wt %, about 55 wt %, about 60 wt %, or any value or range therein. It is to be appreciated that the above ranges should be interpreted as including and supporting any sub-ranges or discrete values (which may or may not be a whole number) that are within the stated range(s).

The polymer matrix may comprise covalent Si—O—Si bonds, that may also advantageously contribute to the flame retardancy of the hydrogel. The polymer matrix may comprise hydrogen bonds between R³ and water disposed within the polymer matrix. The covalent bonds and hydrogen bonds may be crosslinks in the polymer matrix. The polymer matrix may comprise both covalent and hydrogen bonds (that is, when the polymer matrix is double-crosslinked), which may advantageously allow the polymer matrix to exhibit higher mechanical strength, flexibility, and stability as compared to singly-crosslinked polymer matrices (that is, polymer matrices that are cross-linked via covalent or hydrogen bonds, rather than both). This advantageously allows hydrogels comprising such matrices to exhibit properties suitable for demanding electrochemical applications.

The hydrogel may be amorphous, or have an amorphous structure. Advantageously, the hydrogel being amorphous may allow it to possess a large surface area, high pore volume, and/or good flexibility, and thereby provide a large number of active sites.

The polymer matrix may have a porous morphology. Advantageously, the porous morphology may allow the formation of ion transport channels, which may enable efficient ion migration by the charge carriers within the polymer matrix and/or hydrogel.

The polymer matrix may have a pore size in a range of from about 300 nm to about 700 nm, from about 300 nm to about 650 nm, from about 300 nm to about 600 nm, from about 300 nm to about 550 nm, from about 300 nm to about 500 nm, from about 300 nm to about 450 nm, from about 300 nm to about 400 nm, from about 300 nm to about 350 nm, or from about 350 nm to about 700 nm, from about 400 nm to about 700 nm, from about 450 nm to about 700 nm, from about 500 nm to about 700 nm, from about 550 nm to about 700 nm, from about 600 nm to about 700 nm, from about 650 nm to about 700 nm, or about 300 nm, about 350 nm, about 400 nm, about 450 nm, about 500 nm, about 550 nm, about 600 nm, about 650 nm, about 700 nm, or any value or range therein. It is to be appreciated that the above ranges should be interpreted as including and supporting any sub-ranges or discrete values (which may or may not be a whole number) that are within the stated range(s).

The polymer matrix may comprise interconnected nanoparticles cross-linked in a 3D network structure. The nanoparticles may be large molecules having Si—O bonds and organic functional groups that are derived from organosilane A and tetraalkoxysilane B.

The hydrogel may comprise Al(OTF)₃ and a polymer matrix comprising a network of crosslinked poly(propylurea)-co-poly(orthosilicate).

Advantageously, when the hydrogel is used as an electrolyte in an electrochemical cell, the hydrogel as disclosed may exhibit a broadened electrochemical stability window (ESW) of about 2.50 V to about 2.80 V, suppress the hydrogen evolution reaction (HER) in an aqueous electrochemical cell, maintain a hydrogen evolution potential of about −0.60 V to about −0.70 V, achieve an ionic conductivity of about 2×10⁻³ S cm⁻¹ to about 4×10⁻³ S cm⁻¹ at 25° C. with a water content between 20 to 40 wt %. The hydrogel electrolyte may also not be ignited by an exposure to an ignition source of up to 8 seconds, exhibit high mechanical flexibility under various mechanical stresses. The hydrogel may also advantageously be stable when exposed to air during operation of the electrochemical cell. The hydrogel may advantageously demonstrate reversible and uniform deposition and stripping of Al with reduced side reactions without dendrite formation when it is used as an electrolyte in an electrochemical cell.

Provided herein is also a method of preparing a hydrogel, comprising the steps of:
a. adding an organosilane and a tetraalkoxysilane to an aqueous solution of a metal salt; and
b. resting the aqueous solution to form the hydrogel.

The organosilane and the tetraalkoxysilane may undergo copolymerization in step a. Copolymerization may occur via hydrolysis and/or condensation reactions.

Covalent Si—O—Si bonds may be formed within the resultant hydrogel. Hydrogen bonds between the organosilane and the water from the aqueous solution may be formed in step a.

The metal salt may comprise charge carriers and counteranions as described above. The organosilane and tetraalkoxysilane may be as described above.

The molar ratio of the metal salt:organosilane in the aqueous solution may be in a range of from about 1:0.2 to about 1:0.4, from about 1:0.2 to about 1:0.35, from about 1:0.2 to about 1:0.3, from about 1:0.2 to about 1:0.25, or from about 1:0.25 to about 1:0.4, from about 1:0.3 to about 1:0.4, from about 1:0.35 to about 1:0.4, or about 1:0.2, about 1:0.25, about 1:0.3, about 1:0.35, about 1:0.4, or any value or range therein. It is to be appreciated that the above ranges should be interpreted as including and supporting any sub-ranges or discrete values (which may or may not be a whole number) that are within the stated range(s).

The molar ratio of the metal salt:tetraalkoxysilane in the aqueous solution may be in a range of from about 1:0.2 to about 1:0.4, from about 1:0.2 to about 1:0.35, from about 1:0.2 to about 1:0.3, from about 1:0.2 to about 1:0.25, or from about 1:0.25 to about 1:0.4, from about 1:0.3 to about 1:0.4, from about 1:0.35 to about 1:0.4, or about 1:0.2, about 1:0.25, about 1:0.3, about 1:0.35, about 1:0.4, or any value or range therein. It is to be appreciated that the above ranges should be interpreted as including and supporting any sub-ranges or discrete values (which may or may not be a whole number) that are within the stated range(s).

The method may not require a catalyst, or comprise a step of adding or including a catalyst.

The method may further comprise a step of stirring the aqueous solution after step a. The stirring step may allow the aqueous solution to gelate, or transition into a gel state. The crosslinking of the polymer matrix may occur during the stirring step. The stirring step may be performed at a duration of about 10 minutes to about 20 minutes. The stirring step may be performed at about 25° C., or at room temperature.

The resting step (step b) may allow the aqueous solution to gelate, or transition into a gel state. The crosslinking of the polymer matrix may occur during the resting step. The resting step may be performed at a duration of about 10 minutes to 20 minutes. The resting step may be performed at about 25° C., or at room temperature.

The method of preparing the hydrogel may also be considered as a method of forming an electrolyte, where the electrolyte is the hydrogel.

Further provided herein is a hydrogel obtained by the method as disclosed herein. Further provided herein is a hydrogel electrolyte obtained by the method as disclosed herein.

Provided herein is also an electrochemical cell comprising the hydrogel as disclosed herein as an electrolyte. The electrochemical cell may be used for energy storage as a battery. When the charge carrier in the hydrogel is Al³⁺, the electrochemical cell may be used as an aqueous aluminium ion battery together with Al, AlₓMnO₂, and/or KNHCF electrodes. The electrochemical cell may advantageously suppress HER during operation. The HER suppression may occur by mitigation of water decomposition at the electrode/electrolyte interface of the electrochemical cell.

The electrochemical cell comprising the hydrogel may exhibit a stable cycling performance of 0.15 V over 300 hours, and a cycling stability with an initial discharge capacity of about 70 mAh g⁻¹ to about 80 mAh g⁻¹ with a high average Coulombic efficiency of >about 99%, while maintaining a capacity retention of >90% after about 100 to about 500 cycles. The electrochemical cell may further exhibit a constant open circuit voltage (OCV) during a self-discharge process through a resting period of 20 hours, and also exhibit average discharge capacities of about 90 to about 95, about 65 to about 70, about 60 to about 65 and about 55 to about 60 mAh g⁻¹ at current densities of 50, 80, 100 and 150 mA g⁻¹ respectively.

Further provided herein is a use of a hydrogel as disclosed herein as an electrolyte in an electrochemical cell.

### EXAMPLES

Non-limiting examples of the invention and comparative examples will be further described in greater detail by reference to specific examples, which should not be construed as in any way limiting the scope of the invention.

### Example 1: Preparation of Hydrogel and Electrochemical Cell

A hydrogel electrolyte (HE) was prepared using an in-situ sol-gel method. Initially, a 2 M Al(OTF)₃/H₂O aqueous solution was prepared by dissolving 4.74 g aluminum trifluoromethanesulfonate (Al(OTF)₃, obtained from Sigma-Aldrich, USA) in 5 mL of deionized water. Then, 0.6 mL of tetraethyl orthosilicate (TEOS, obtained from Sigma-Aldrich, USA) and 0.6 mL of 1-[3-(trimethoxysilyl)propyl]urea (TU, obtained from Sigma-Aldrich, USA) were added to the aqueous solution (containing 1 mM Al(OTF)₃) respectively and stirred without a bottle cap for about 10 to 20 minutes at room temperature. As the stirring time increased, the solution gradually thickened. Battery assembly and electrolyte gelation were carried out simultaneously. In detail, before the solution transitioning into a gel state, the viscous solution was injected into a 16 mm diameter glass fiber (GF-A, Whatman), followed by packaging the battery. Subsequently, it underwent gelation during the battery's resting time.

The full battery was fabricated using Al foil (obtained from Sigma-Aldrich, USA) as the anode electrode and potassium nickel hexacyanoferrate (KNHCF, obtained from Sigma-Aldrich, USA) or MnO (obtained from Sigma-Aldrich, USA) as the cathode electrode. The KNHCF material as well as the MnO cathode were synthesized according to known methods. The cathode electrode was prepared by mixing the active material powder, super P (obtained from Sigma-Aldrich, USA) and polyvinylidene difluoride (PVDF, obtained from Sigma-Aldrich, USA) binder in N-methyl pyrrolidone (NMP, obtained from Sigma-Aldrich, USA) solvent at a mass ratio of 6:2:2 to form the cathode slurry. The slurry was evenly coated onto hydrophobic carbon paper and then vacuum-dried at 80° C. for 12 hours. The symmetrical Al∥Al battery was assembled using Al foil as the electrode, and the hydrogel polymerization process was carried out simultaneously with the battery assembly process.

2 M Al(OTF)₃/H₂O aqueous solution was used as a liquid electrolyte (LE) for comparison purposes.

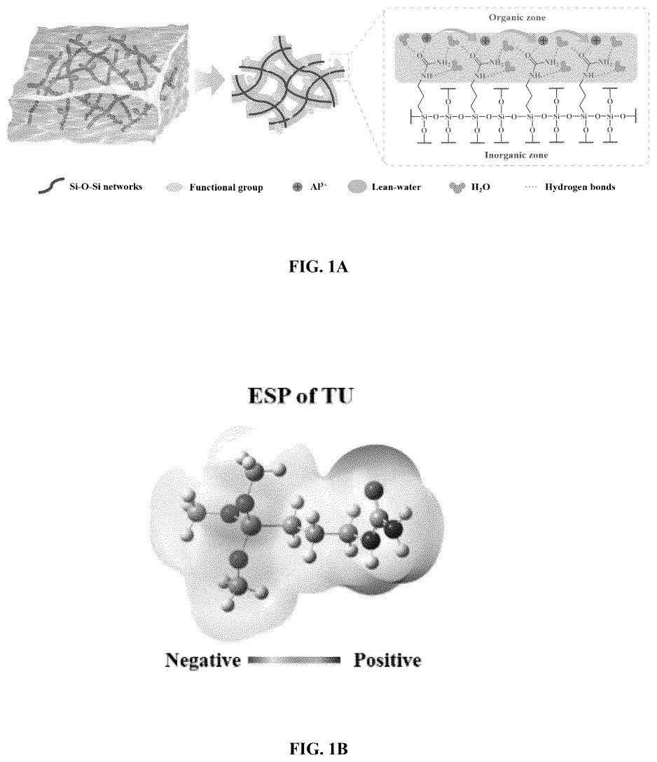

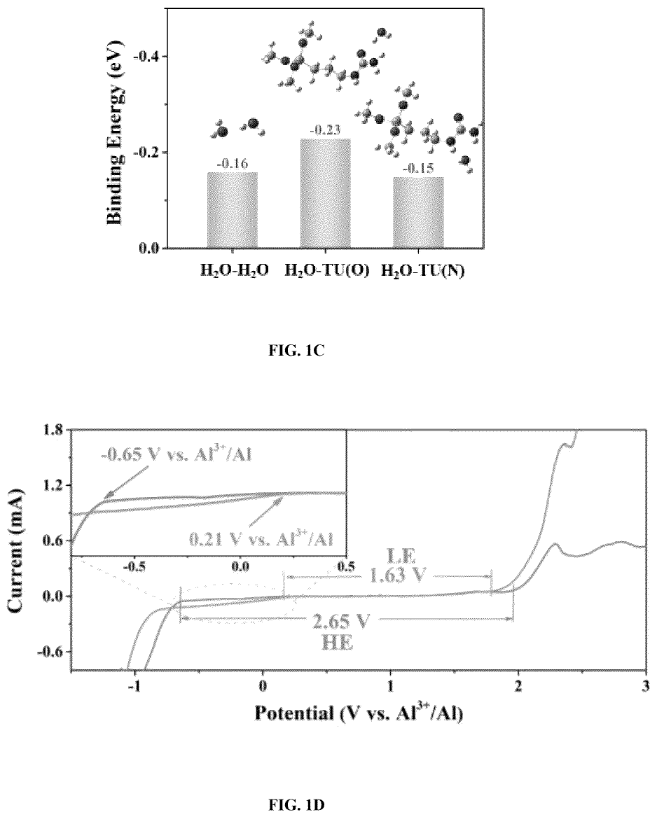

During the process, TU and TEOS undergo copolymerization to form an inorganic/organic hybrid three-dimensional (3D) structure. This copolymerization occurs via hydrolysis and condensation reactions in an acidic Al(OTF)₃/H₂O solution, without requiring additional catalysts. Numerous polar groups promote the aggregation of H₂O molecules around the Si—O—Si chains, while strongly electronegative carboxyl oxygen atoms establish ion transport channels, facilitating rapid ion migration under lean-water conditions (FIG. 1A).

### Example 2: Characterization of Hydrogel

### Material Characterizations

The SEM images were performed with a field-emission SEM (JEOL JSM-7600F). FTIR spectra of TU, LE and HE were obtained on Thermo Scientific Nicolet iS50 spectrometer. The XRD spectrum of HE was analyzed through Bruker D2 Phaser. The combustion tests of the HE and LE were measured via high-temperature Flame Gun. The XPS depth profiling of cycled Al electrodes were collected using an XPS spectrometer (Kratos Axis Supra) equipped with an Al Kα X-ray source. The 3D spatial distribution of the SEI structure was analyzed by TOF-SIMS (PHI nano TOF 11) with an Ar ion gun. The H₂ evolution was measured by HPR-40 differential electrochemical mass spectrometry in a full battery system. The bubbles at Al/electrolyte interphase were observed by Leica DVM6 optical microscope in a symmetrical Al battery system.

### Electrochemical Measurements

LSV curves of electrolytes were measured by the Autolab PGSTAT204 electrochemical workstation. EIS was also tested by the Autolab PGSTAT204. The electrochemical performances of symmetric Al batteries and full batteries were evaluated with a Neware battery testing system (BTS4000). The 2032-type coin was employed in these battery systems. In-situ DEMS battery was tested using the CT2001A LAND testing system.

### Density Functional Theory (DFT) Simulations

Geometry optimizations were performed using the unrestricted B3LYP hybrid density functional implemented in Gaussian 16 suite of program. No symmetry constrain was applied. The 6-311+G (d,p) basis sets are adopted for all atoms. “Tight” optimizations and “ultrafine” integration grid were specified for the DFT calculations. GD3 empirical dispersion corrections were applied. The implicit universal water solvation model based on SMD was applied. The binding energy (E_{b}) was calculated using the equation: E_{b}=E_{AB}−(E_{A}+E_{B}) where E_{AB} and E_{A}(E_{B}) are the total energies of the binded molecule/ion AB and the isolated molecule/ion A(B), respectively. The more negative the binding energy, the stronger the binding strength.

The interaction between hydrogel chains and water was investigated using density functional theory (DFT) analysis. The electrostatic potential (ESP) distribution was initially analyzed to visualize the electronegative and electropositive regions within the TU molecule (FIG. 1B). The negative region near the carboxyl oxygen atom and the positive region associated with the amino hydrogen atom suggest that the former can serve as a hydrogen bond acceptor, while the latter can function as a hydrogen bond donor.

To quantify these interactions, the binding energies of H₂O—H₂O, H₂O-TU(O), and H₂O-TU(NH) were calculated, as shown in FIG. 1C. Specifically, the binding energy of H₂O-TU(O) (0.23 eV) is notably higher than that of the H₂O—H₂O dimer (0.16 eV), indicating a stronger electrostatic interaction between H₂O and TU(O). Additionally, the binding energy of H₂O-TU(NH) (0.15 eV) is comparable to that of water dimers, suggesting a competitive interaction for hydrogen bonding between water and NH. This competition can also disrupt the hydrogen bond network among water molecules. These findings demonstrate the anchoring effect of polar functional groups in the Si—O—Si chains with water molecules, reducing the water activity, mitigating the HER, and contributing to the broadening of the ESW.

Linear sweep voltammetry (LSV) measurements were performed to experimentally validate the theoretical findings. Stainless steel (SS)|electrolyte|Al cells were assembled for this purpose, where SS served as the work electrode and Al foil functioned as both the counter and reference electrodes. As shown in FIG. 1D, the hydrogel exhibited a significantly broader ESW of 2.65 V vs. Al³⁺/Al, compared to that of aqueous liquid electrolyte (1.63 V vs. Al³⁺/Al). Notably, its hydrogen evolution potential was approximately −0.65 V vs. Al³⁺/Al, which is sufficiently low to enable reversible Al deposition. This result confirms that the polar group-based hydrogel effectively mitigates HER by forming hydrogen bonds with water, thereby reducing water reactivity and stabilizing the interface.

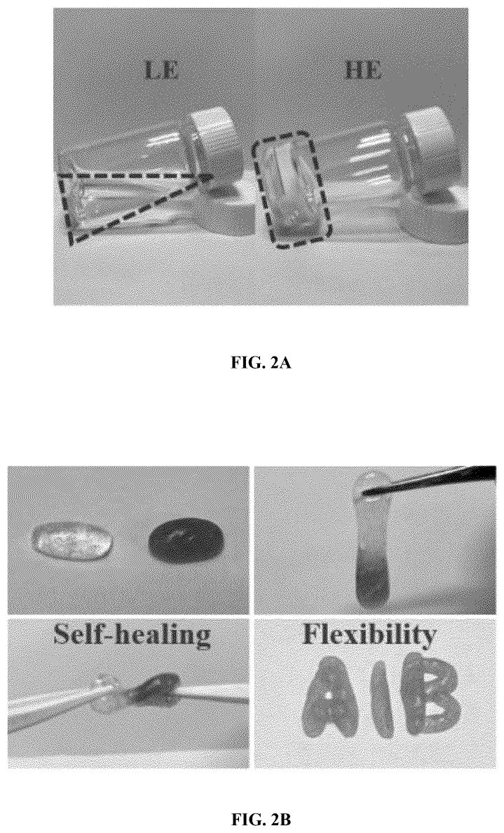

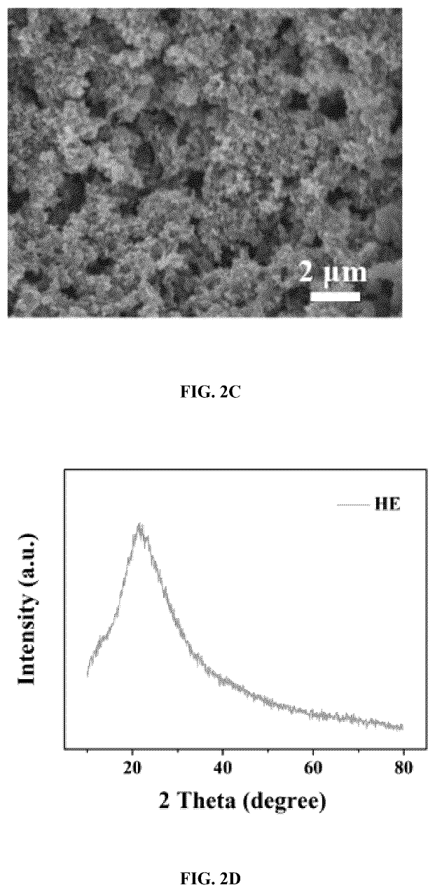

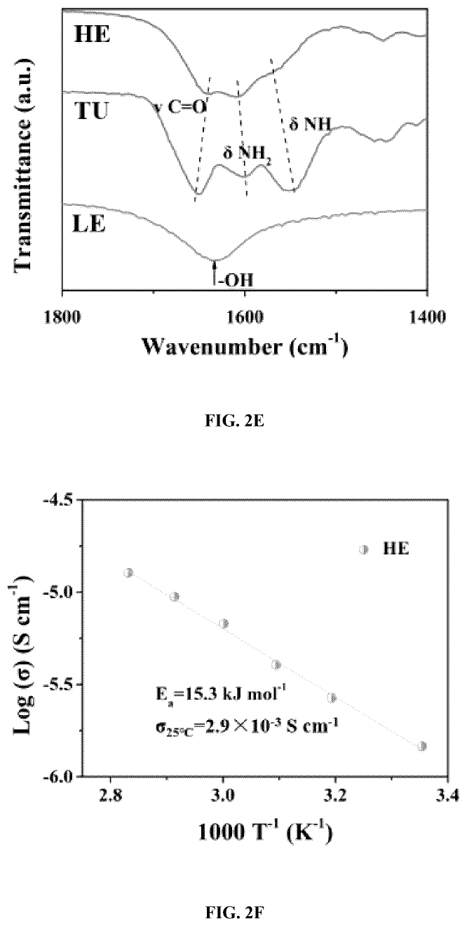

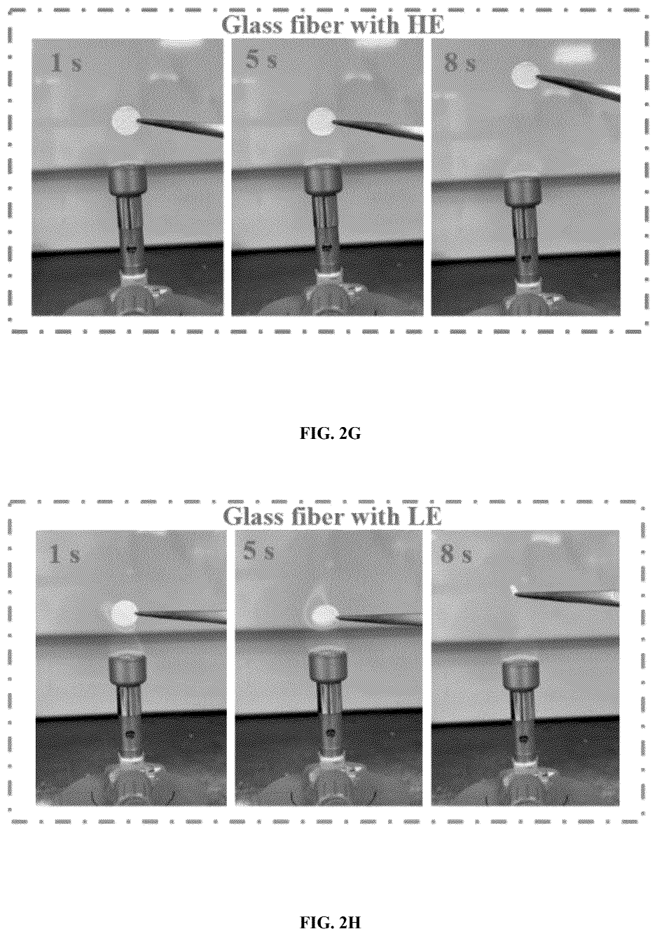

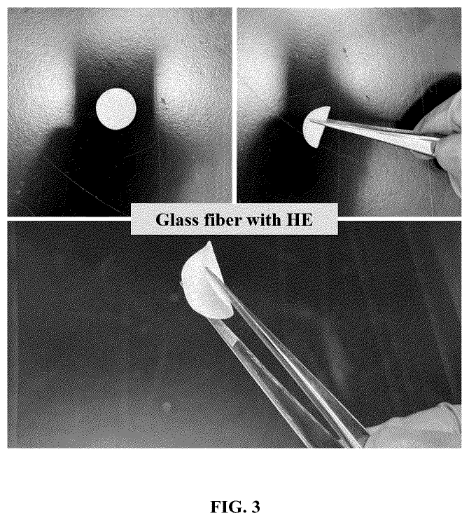

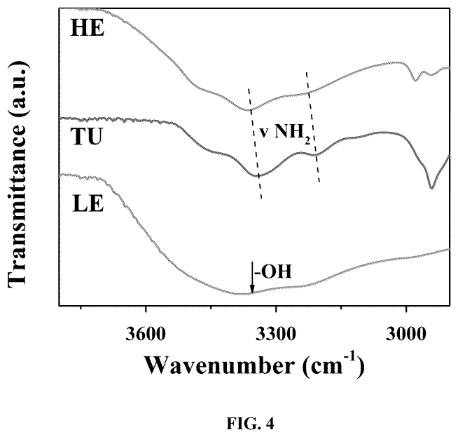

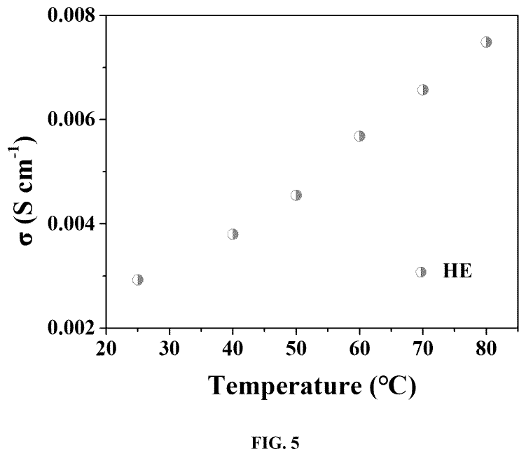

The optical photographs of the electrolyte before and after copolymerization are presented in FIG. 2A. Following the incorporation of crosslinkers and the polymerization process, the hydrogel exhibited macroscopic morphological stability, which can be attributed to its unique 3D network structure. Additionally, the hydrogel exhibited good self-healing properties and mechanical flexibility, as shown in FIGS. 2B and 3, highlighting its potential for enhancing battery safety and enabling wearable applications.

The microstructure of the hydrogel skeleton was then investigated using SEM. It is clear that the Si—O—Si matrix forms a 3D network structure composed of numerous interconnected nanoparticles (FIG. 2C). This porous morphology, combined with hydrophilic functional groups, facilitates the formation of fast Al³⁺ ion transport channels, enabling efficient ion migration within the electrolyte.

The crystallinity of hydrogel synthesized via sol-gel polymerization was further analyzed using XRD. As shown in FIG. 2D, the broad peak observed around 220 corresponds to the amorphous SiO₂. Since amorphous SiO₂ possessed a large surface area, high pore volume, and good flexibility, numerous active sites are thereby provided.

Hydrogel electrolytes can generally be classified into two types based on their cross-linking modes: chemical and physical, which are closely associated with their mechanical properties, thermal stability, reliability, and durability. In this example, the hydrogel is double-crosslinked through both physical (hydrogen bonds) and chemical (covalent bonds) interactions to form an amorphous structure. Double-crosslinked hydrogels exhibit superior mechanical strength, flexibility, and stability compared to their single-crosslinked counterparts, making them highly advantageous for demanding electrochemical applications.

To further elucidate the hydrogen bond interactions between functional groups in the hydrogel skeleton and H₂O molecules, FTIR tests were employed. In FIGS. 2E and 4, the peaks at approximately 1650 cm⁻¹, 1600 cm⁻¹ and 1500 cm⁻¹ corresponded to the —C═O, —NH₂ and —NH— groups in TU, respectively. In the FTIR spectra of hydrogel, a red shift was observed in the stretching vibration of —C═O, while a blue shift appeared in the bending vibration of —NH₂ and —NH—. These shifts were attributed to hydrogen bond interactions between the functional groups and H₂O, which is in consistent with the DFT calculations.

Ionic conductivity is a crucial parameter for evaluating the application potential of electrolytes. Electrochemical impedance spectroscopy (EIS) tests were conducted in SS|hydrogel|SS cells. Interestingly, a high ionic conductivity of 2.9×10⁻³ S cm⁻¹ at 25° C. was obtained even under the lean-water conditions with a water content of 23 wt % (FIG. 5). As depicted in FIG. 1A, the abundant polar groups promote the aggregation of H₂O molecules around the Si—O—Si chains, facilitating rapid ion migration along the carboxyl oxygen atoms even at reduced water content. Besides, the activation energy (Eₐ), calculated from the Arrhenius plots via linear fitting, was determined to be 15.3 kJ mol⁻¹, indicating a low migration barrier for Al³⁺ ions within the hydrogel (FIG. 2F and Table 1). This result highlights the hydrogel's ability to maintain efficient ion transport, which is critical for high-performance AAIBs.

TABLE 1
Arrhenius parameters of HE

| Electrolyte | Eₐ | A | r² |
|---|---|---|---|
| HE | 15.3 kJ mol⁻¹ | 1.413 | >0.99 |

### Example 3: Combustion Performance of Hydrogel

Combustion tests were conducted to evaluate the flammability and safety of the hydrogel. In this test, glass fibers were immersed in the hydrogel precursor solution and subsequently underwent a polymerization process. Ignition tests were then performed to assess the flame resistance. As depicted in FIG. 2G, no burning occurred even when the ignition time is extended to 8 seconds. This excellent flame retardancy was attributed to the strong Si—O bonds within the hydrogel matrix and the release of inert N₂ generated from the thermal decomposition of amino groups. In contrast, the glass fiber soaked with LE exhibited combustibility (FIG. 2H). This result indicated the insufficient flame retardancy of the LE, which was unable to inhibit burning of glass fiber under the same conditions. These findings demonstrated the significant safety advantages of the hydrogel, making it a more preferable choice for next-generation energy storage systems, particularly in applications where thermal stability and safety are critical.

### Example 4: Electrochemical Performance of Hydrogel

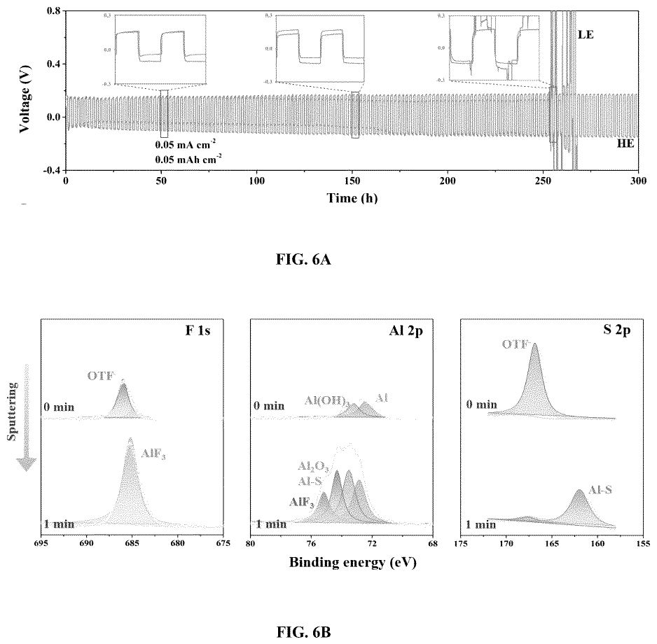

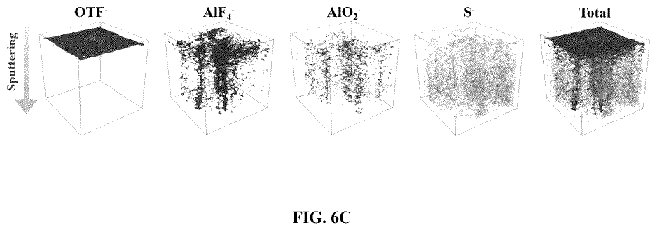

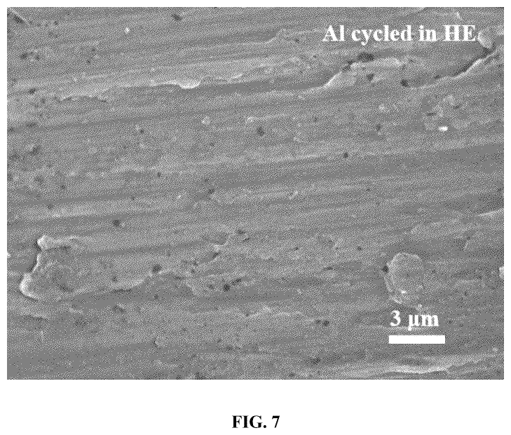

The plating and stripping behavior of the Al was investigated through galvanostatic charge/discharge tests on symmetrical cells. FIG. 6A presents the cycling performance of the Al|HE|Al cell at a current density of 0.05 mA cm⁻², with the Al|LE|Al cell as the control sample. In the Al|LE|Al cell, a fluctuating overpotential was observed, and the cell suddenly failed after 250 hours of cycling. This behavior indicated uneven and irreversible Al plating in the aqueous liquid electrolyte due to side reactions and poor electrode compatibility. In contrast, the symmetrical cell based on HE exhibited stable voltage polarization profiles (~0.15 V) over 300 hours, demonstrating the reversible and uniform deposition/stripping of Al, with reduced side reactions. To further confirm the interfacial behavior, the microstructure of the Al electrode cycled in the HE was examined using SEM. The SEM image displayed a smooth and dense Al surface without dendrite formation, proving clear evidence of the hydrogel's ability to enable uniform and reversible plating/stripping (FIG. 7). In short, these results highlight that the hydrogel effectively mitigated side reactions and enhanced the reversibility of Al deposition/stripping in AAIBs.

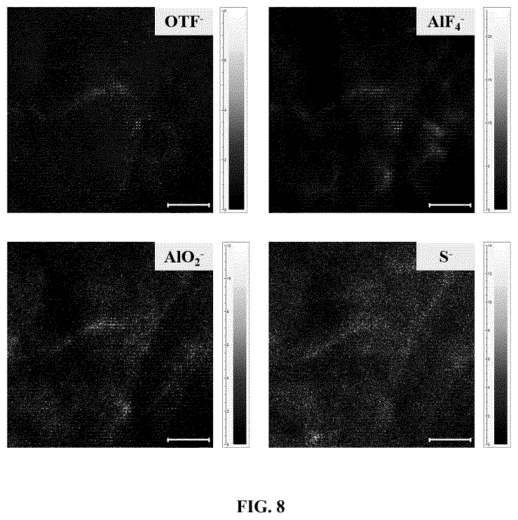

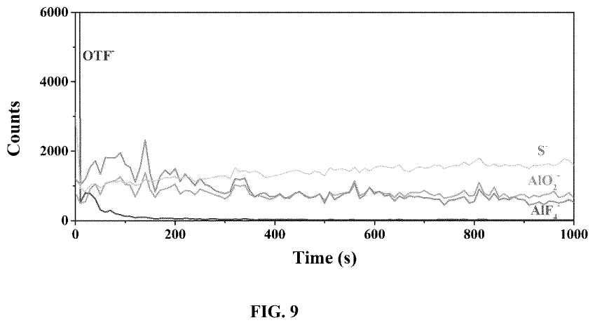

To further elucidate the protective mechanism at the Al/HE interface, in-depth XPS and TOF-SIMS techniques were performed to study the composition and structure of SEI. Following 50 hours of cycling, the Al electrode was disassembled from the Al|HE|Al cell. XPS tests were initially conducted. As shown in FIG. 6B, XPS spectra revealed that the outside layer of the Al electrode primarily consisted of residual Al(OTF)₃ salt. Following a 1 minute etching process, the SEI layer was found to be dominated by inorganic components, including Al—F, Al—S, and Al—O species. Further insights into the interface behavior were obtained through TOF-SIMS analysis, which provided 3D spatial distribution of the SEI structure. As shown in FIG. 6C, residual OTF was observed on the surface. The AlF₄⁻, AlO₂⁻ and S⁻ secondary ions are detected within the SEI layer, which was consistent with the XPS results (FIGS. 7 and 8). These components were primarily attributed to the preferential reductive decomposition of OTF anions. The parasitic HER in aqueous electrolyte could be kinetically suppressed though the formation of an SEI enriched with inorganic components. Such an SEI served as a protective barrier, promoting Al nucleation and uniform deposition while avoiding direct contact between water and Al metal, thereby mitigating side reactions and facilitating long-term cycling performance.

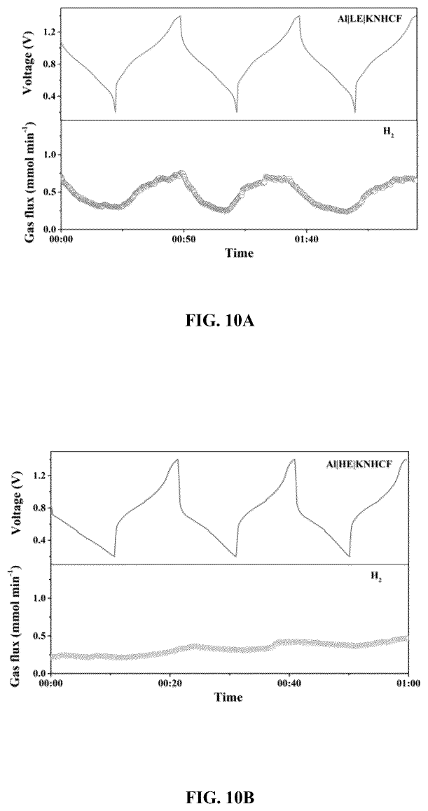

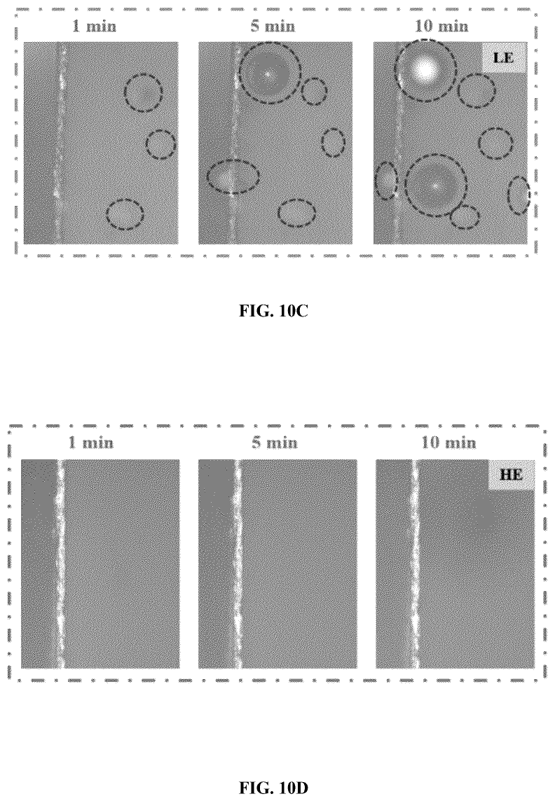

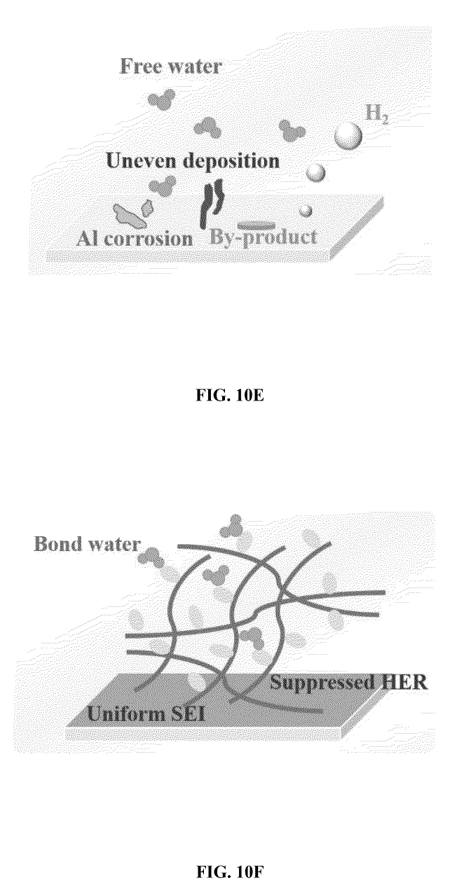

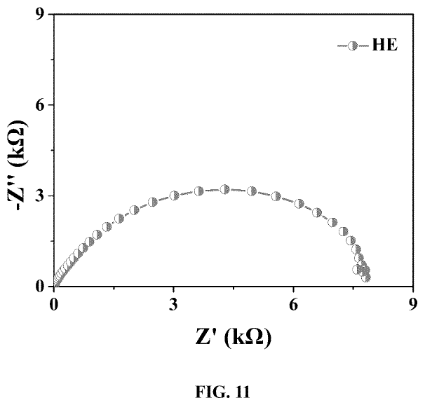

To visually observe the HER in both hydrogel and liquid electrolyte systems, in-situ DEMS measurements were conducted on Al∥KNHCF full cells to record the H₂ evolution during the first three cycles. As shown in FIG. 10A, a pronounced H₂ evolution signal was detected during each charging process in the liquid electrolyte, indicating severe water decomposition occurring prior to Al deposition. In contrast, HER was effectively suppressed in the hydrogel-based cell, with reduced H₂ generation observed during cycling (FIG. 10B). These findings were further supported by in-situ optical microscopy tests, which provided a real-time observation of gas evolution at the interface. The optical images of gas evolution in the Al|LE|Al and Al|HE|Al batteries at a current density of 0.3 mA cm⁻² are shown in FIGS. 10C and 10D, respectively. Continuous bubbles were observed in the liquid electrolyte from 1 to 10 minutes, confirming the severe HER during cell operation (FIG. 10C). In contrast, minimal bubble generation was observed at the Al|HE interface under the same current density, which was consistent with the results obtained from in-situ DEMS analysis (FIG. 10D). These results further demonstrated the ability of the hydrogel to effectively mitigate water decomposition at the Al/electrolyte interface. This stabilization is critical for enabling highly efficient and reversible Al deposition, thus contributing to the long-term cycling stability of AAIBs.

Based on these in-situ tests, the mitigated HER in the hydrogel system may be attributed to a combination of thermodynamic and kinetic protective mechanisms:
1) Thermodynamically, the formation of hydrogen bonds between the polar functional groups in the Si—O—Si chains and H₂O molecules effectively reduces water reactivity, thereby suppressing HER; and
2) Kinetically, a stable and robust SEI, induced by the hydrogel, promotes uniform deposition of Al while avoiding direct contact between water and Al metal, thus mitigating side reactions.

As illustrated in FIGS. 10E and 10F, the combined effects of increased bonded water and the formation of a stable SEI resulted in remarkable inhibition of HER. From these two mechanisms, reversible electrochemical performance can be achieved.

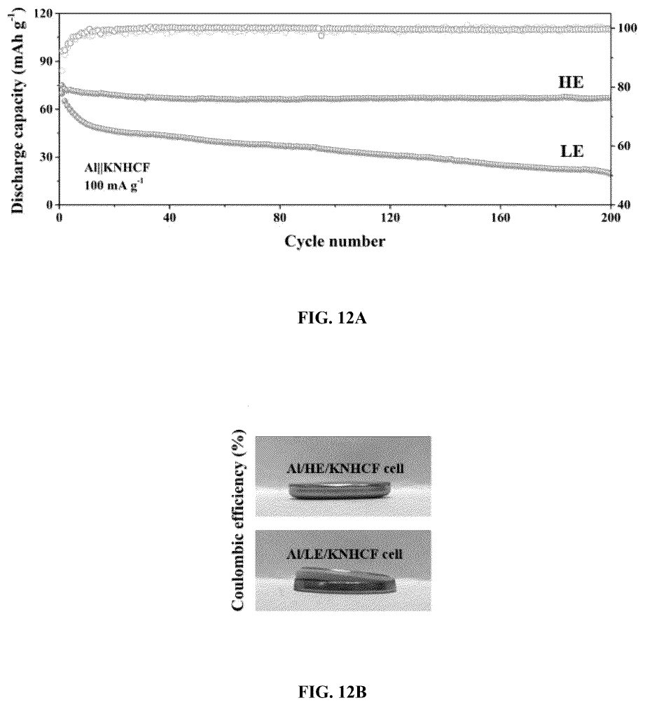

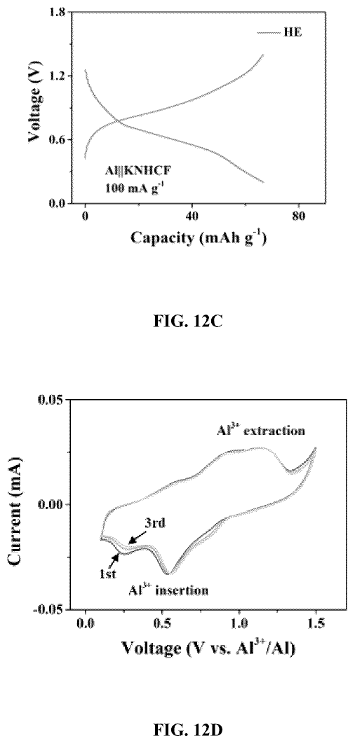

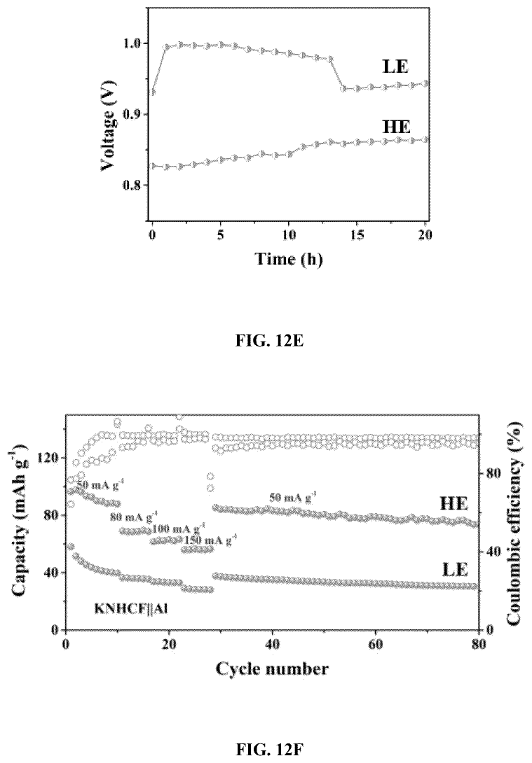

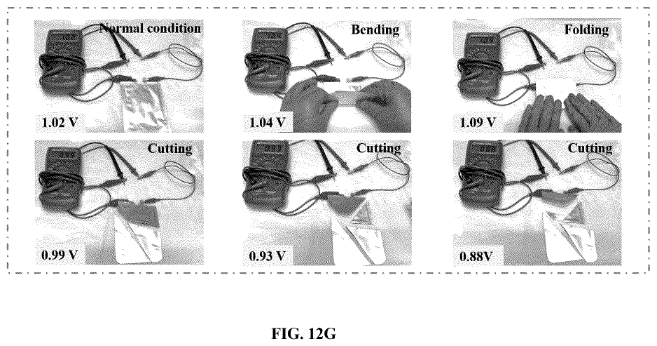

Next, Al∥KNHCF full batteries were fabricated to evaluate the long-term electrochemical performance. The Nyquist plots of the fresh full cell are shown in FIG. 11. At a current density of 100 mA g⁻¹, the Al|HE|KNHCF cell exhibited outstanding cycling stability, delivering an initial discharge capacity of 74.9 mAh g⁻¹ with a high average Coulombic efficiency of 99.6% (FIG. 12A). After 200 cycles, the capacity retention remains at 90.0%. In sharp contrast, the LE-based full cell exhibited low specific discharge capacity and accelerated capacity degradation. In detail, only 27.8% of its initial capacity was retained after 200 cycles, which was caused by the continuous side reactions. FIG. 12B compares the appearance of the coin cells after cycling. It can be clearly seen that the LE-based coin cell visibly ruptured due to pronounced H₂ evolution during cycling, while the Al|HE|KNHCF coin cell remained largely intact. This can be attributed to the unique hydrogel design, which suppressed HER and stabilized the SEI layer. The corresponding charge/discharge profiles of the 40^{th} cycle in FIG. 12C showed the small voltage polarization and a stable voltage plateau. A higher specific discharge capacity (~68 mAh g⁻¹) was achieved compared to other AAIBs utilizing Prussian blue analogue cathodes.

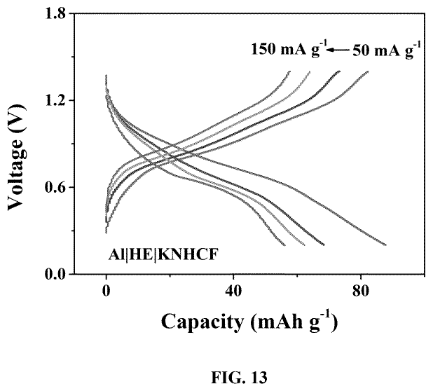

FIG. 12D presents the cyclic voltammetry (CV) curves of the Al|HE|KNHCF full cell at a scan rate of 0.3 mV s⁻¹ within the voltage range of 0.1-1.5 V. It is noteworthy that the oxidation and reduction peaks correspond to the Al³⁺ extraction and insertion processes, respectively. No obvious alterations were observed in the CV curves during the first three cycles, which can be attributed to the low polarization and the presence of large ion channels in KNHCF cathode. To evaluate the internal stability of the cell, the self-discharge process was monitored over a resting period of 20 hours. The open circuit voltage (OCV) of the Al|LE|KNHCF full cell exhibited a gradual decrease within the first 12 hours of standing, as depicted in FIG. 12E. A sudden drop occurred at 13 hours, indicating persistent internal self-discharge (associated with side reactions) and poor compatibility between the aqueous electrolyte and electrode materials. In contrast, the HE-based cell maintained a constant OCV throughout the resting period, signifying a stable hydrogel and interface. The rate performance of the Al|HE|KNHCF full cell was further assessed across a range of current densities from 50 to 150 mA g⁻¹ (FIG. 12F). The cell demonstrated average discharge capacities of 92.0, 68.8, 62.4 and 56.1 mAh g⁻¹ at current densities of 50, 80, 100 and 150 mA g⁻¹, respectively, which significantly outperformed those of LE-based full cell. Importantly, when the current density was returned to 50 mA g⁻¹, the capacity recovered to 85.3 mAh g⁻¹. The corresponding charge/discharge curves, as presented in FIG. 13, exhibit good electrochemical performance with respect to specific capacity and voltage plateau.

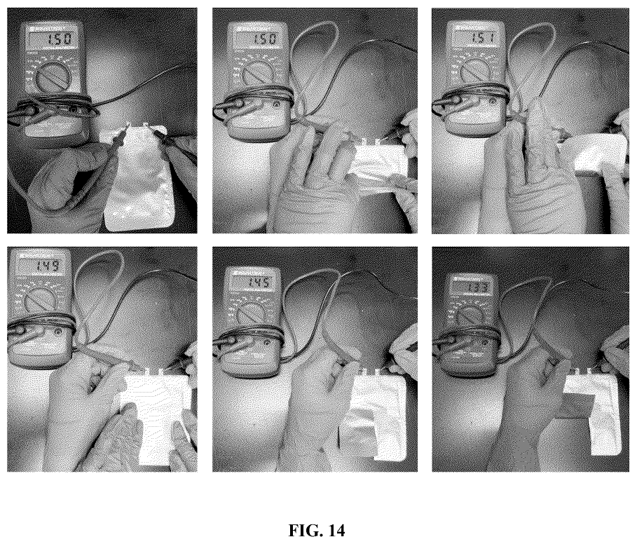

Finally, pouch cells were constructed to evaluate the flexibility and safety of the Al|HE|KNHCF (FIG. 12G) and Al|HE|AlₓMnO₂ (FIG. 14) systems under various mechanical stresses. As displayed in FIG. 12G, the Al|HE|KNHCF pouch cell exhibited an OCV of 1.02 V under normal conditions. Remarkably, its OCV remained stable even after subjecting the pouch cell to bending (90°) and folding (180°), highlighting its excellent mechanical flexibility. Moreover, when the pouch was cut into pieces, only a slight reduction in OCV was observed, and no signs of electrolyte leakage or short-circuiting were detected. Owing to its inherent stable physical and chemical properties, the aqueous silicon-based hydrogel maintained a normal OCV when exposed to air, thereby demonstrating its potential for achieving flexible and high safety AAIBs.

### INDUSTRIAL APPLICABILITY

The present invention relates to hydrogel electrolytes for use in electrochemical cell applications. The hydrogels of the present invention possess high electrochemical stability and ionic conduction even at low water content, and effectively suppresses the hydrogen evolution reaction in electrochemical cells. The hydrogels also exhibit high mechanical flexibility, flame retardancy.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A hydrogel comprising:
a charge carrier; and
a polymer matrix comprising a network of crosslinked poly(A)-co-poly(B),
wherein A is an organosilane and B is a tetraalkoxysilane.

2. The hydrogel of claim 1, wherein A is a compound of Formula (I) 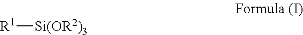
wherein R¹ is a C₁-C₆alkyl substituted with at least one R³;
each R² is independently a C₁-C₆alkyl; and
R³ is a polar functional group.

3. The hydrogel of claim 2, wherein R³ is independently selected from the group consisting of —NH₂, —OH, —C(O)OH, —C(O)—NH₂, —O—C(O)—(CH₃)C═CH₂ and —N(H)—C(O)—NH₂.

4. The hydrogel of claim 3, wherein A is selected from the group consisting of 1-[3-(trimethoxysilyl)propyl]urea, (3-aminopropyl)triethoxysilane and 3-(trimethoxysilyl)propyl methacrylate.

5. The hydrogel of claim 1, wherein B is Si(OR⁴)₄, wherein each R⁴ is independently a C₁-C₆ alkyl.

6. The hydrogel of claim 1, wherein the charge carrier comprises Al³⁺, Zn²⁺, Li⁺, Na⁺, K⁺, Ca²⁺, or Mg²⁺.

7. The hydrogel of claim 1, wherein the polymer matrix is a three-dimensional (3D) inorganic/organic hybrid structure.

8. The hydrogel of claim 1, wherein the hydrogel further comprises water at a water content of about 20 wt % to about 60 wt %.

9. The hydrogel of claim 8, wherein the polymer matrix comprises covalent Si—O—Si bonds and hydrogen bonds between R³ and water disposed within the polymer matrix as crosslinks.

10. The hydrogel of claim 1, wherein the hydrogel is amorphous.

11. The hydrogel of claim 1, wherein the polymer matrix has a pore size of about 300 nm to about 700 nm.

12. The hydrogel of claim 1, comprising:
Al(OTF)₃; and
a polymer matrix comprising a network of crosslinked poly(propylurea)-co-poly(orthosilicate).

13. A method of preparing a hydrogel, comprising the steps of:
a. adding an organosilane and a tetraalkoxysilane to an aqueous solution of a metal salt; and
b. resting the aqueous solution to form the hydrogel.

14. The method of claim 13, wherein the organosilane and the tetraalkoxysilane undergo copolymerization in step a.

15. The method of claim 13, wherein covalent Si—O—Si bonds and hydrogen bonds between the organosilane and water from the aqueous solution are formed within the hydrogel in step a.

16. The method of claim 13, wherein the molar ratio of the metal salt:organosilane:tetraalkoxysilane is about 1:0.2-0.4:0.2-0.4.

17. A hydrogel obtained by the method of claim 13.

18. An electrochemical cell comprising the hydrogel of claim 1 as an electrolyte.

19. An electrochemical cell comprising the hydrogel of claim 17 as an electrolyte.
